(19) United States
(12) Patent Application Publication
(10) Pub. No.: US 2012/0268680 A1
(43) Pub. Date: Oct. 25, 2012

(54) DISPLAY PANEL AND DISPLAY DEVICE

(75) Inventors: Hiroki Sugiyama, Tottori (JP); Toshiharu Matsushima, Tottori (JP)

(73) Assignee: SONY CORPORATION, Tokyo (JP)

(21) Appl. No.: 13/445,637

(22) Filed: Apr. 12, 2012

(30) Foreign Application Priority Data
Apr. 20, 2011 (JP) 2011-094268

(51) Int. Cl. G02F 1/1368; G02F 1/1343

(52) U.S. Cl. 349/43; 349/143; 349/113

(57) ABSTRACT

A display panel includes: a liquid crystal element; and a transistor including a gate electrode, a source electrode, and a drain electrode. The liquid crystal element and the transistor are provided for each sub-pixel, and the drain electrode serves as a pixel electrode that drives the liquid crystal element.

### BACKGROUND

The present technology relates to a display panel of a reflective type or a semi-transmissive type which combines a reflecting section with a transmitting section, and to a display device provided with the display panel.

In recent years, there has been a growing demand for display devices designed for mobile devices such as mobile phones and electronic paper, and reflective display devices are thus attracting attention. A reflective display device does not need a backlight since the reflective display device performs display by reflecting light incoming from the outside (ambient light) with a reflector. For this reason, the power consumption of a reflective display device can be reduced by that of a backlight, and this makes it possible to operate a mobile device for a longer time, compared to a case where a transmissive display device is used. Further, since a reflective display device does not need a backlight, it is possible to reduce the weight and size of a reflective display device by those of a backlight.

A reflective display device includes a layer with a scattering function, in order to perform display using outside light. For example, Japanese Patent No. 2771392 discloses applying a scatting function to a reflecting electrode by providing the reflecting electrode with a convexo-concave shape. Further, Japanese Unexamined Patent Application Publications No. H11-237623, No. H09-113893, and No. 2002-244134 disclose providing a scattering film on an upper surface of a glass substrate, instead of providing a reflecting electrode with a convexo-concave shape. The scattering film described in Japanese Unexamined Patent Application Publication No. H11-237623 is a forward scattering film having an increased forward scatting property and a decreased backward scatting property. The scattering films described in Japanese Unexamined Patent Application Publications No. H09-113893 and No. 2002-244134 are anisotropic forward scattering films which scatter light incoming from a specific direction. The anisotropic forward scattering film described in Japanese Unexamined Patent Application Publication No. H09-113893 makes outgoing light scatter and incoming light hardly scatter. The anisotropic forward scattering film described in Japanese Unexamined Patent Application Publication No. 2002-244134 makes outgoing light hardy scatter and incoming light scatter.

### SUMMARY

In a reflective display device, in order to increase the reflectivity derived from a reflecting electrode, an interlayer insulating film is typically formed throughout the entire surface that includes a TFT, and the reflecting electrode is formed on the interlayer insulating film. However, creating such a configuration requires a large number of process steps, preventing a reduction in manufacturing cost.

It is desirable to provide a display panel capable of reducing the number of process steps, and a display device provided with the display panel.

A first display panel according to an embodiment of the present technology includes: a liquid crystal element; and a transistor including a gate electrode, a source electrode, and a drain electrode. The liquid crystal element and the transistor are provided for each sub-pixel, and the drain electrode serves as a pixel electrode that drives the liquid crystal element.

A first display device according to an embodiment of the present technology is provided with a display panel and a driving section. The display panel includes a plurality of sub-pixels arranged in matrix, and the driving section that drives the display panel. The display panel includes: a liquid crystal element; and a transistor including a gate electrode, a source electrode, and a drain electrode, wherein the liquid crystal element and the transistor are provided for each of the sub-pixels, and the drain electrode serves as a pixel electrode that drives the liquid crystal element.

In the first display panel and the first display device according to the embodiments of the present technology, the drain electrode of the transistor in each of the sub-pixels itself serves as the pixel electrode that drives the liquid crystal element.

A second display panel according to an embodiment of the present technology includes: a liquid crystal element including, as a multilayer, a pixel electrode, a counter electrode, and a liquid crystal layer disposed in between; and a transistor including a gate electrode, a source electrode, and a drain electrode. The liquid crystal element and the transistor are provided for each sub-pixel, and the pixel electrode is connected to the drain electrode and is arranged in a same layer as a layer provided with the drain electrode.

A second display device according to an embodiment of the present technology is provided with a display panel and a driving section. The display panel includes a plurality of sub-pixels arranged in matrix, and the driving section that drives the display panel. The display panel includes: a liquid crystal element including, as a multilayer, a pixel electrode, a counter electrode, and a liquid crystal layer disposed in between; and a transistor including a gate electrode, a source electrode, and a drain electrode, wherein the liquid crystal element and the transistor are provided for each of the sub-pixels, and the pixel electrode is connected to the drain electrode and is arranged in a same layer as a layer provided with the drain electrode.

In the second display panel and the second display device according to the embodiments of the present technology, the pixel electrode in each of the sub-pixels is connected to the drain electrode of the transistor, and is arranged in the same layer as the layer of the drain electrode.

A third display panel according to an embodiment of the present technology includes: a plurality of gate lines arranged in rows; a plurality of data lines arranged in columns; and a plurality of sub-pixels arranged in matrix, corresponding to a layout of the gate lines and the data lines. Each of the sub-pixels includes a liquid crystal element and a transistor. The liquid crystal element includes, as a multilayer, a pixel electrode, a counter electrode, and a liquid crystal layer disposed in between, and the pixel electrode is arranged in a same layer as a layer provided with the data lines.

A third display device according to an embodiment of the present technology is provided with a display panel and a driving section. The display panel includes a plurality of sub-pixels arranged in matrix, and the driving section that drives the display panel. The display panel includes: a plurality of gate lines arranged in rows; a plurality of data lines arranged in columns; and a plurality of sub-pixels arranged in matrix, corresponding to a layout of the gate lines and the data lines. Each of the sub-pixels includes a liquid crystal element and a transistor, wherein the liquid crystal element includes, as a multilayer, a pixel electrode, a counter electrode, and a liquid crystal layer disposed in between, and the pixel electrode is arranged in a same layer as a layer provided with the data lines.

In the third display panel and the third display device according to the embodiments of the present technology, the pixel electrode of each of the sub-pixels is arranged in the same layer as the layer of the data lines.

In the first display panel and the first display device according to the embodiments of the present technology, the drain electrode itself is configured to function as the pixel electrode that drives the liquid crystal element. Hence, it is possible to reduce the number of process steps, as compared with a case, for example, where an interlayer insulating film is formed throughout the entire surface that includes a transistor and a reflecting electrode is formed on the interlayer insulating film.

In the second display panel and the second display device according to the embodiments of the present technology, the pixel electrode is connected to the drain electrode of the transistor, and is arranged in the same layer as the layer of the drain electrode. Hence, it is possible to reduce the number of process steps, as compared with a case, for example, where an interlayer insulating film is formed throughout the entire surface that includes a transistor and a reflecting electrode is formed on the interlayer insulating film.

In the third display panel and the third display device according to the embodiment of the present technology, the pixel electrode is arranged in the same layer as the layer of the data lines. Hence, it is possible to reduce the number of process steps, as compared with a case, for example, where an interlayer insulating film is formed throughout the entire surface that includes a transistor and a reflecting electrode is formed on the interlayer insulating film.

It is to be understood that both the foregoing general description and the following detailed description are exemplary and are intended to provide further explanations of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a schematic block diagram illustrating a liquid crystal display according to a first embodiment of the present technology.

FIG. 2 is a configuration diagram illustrating a pixel array section shown in FIG. 1.

FIG. 3 is a layout diagram illustrating the pixel array section shown in FIG. 1.

FIG. 4 is a cross-sectional view illustrating the pixel array section shown in FIG. 1.

FIG. 5 is a schematic block diagram illustrating a liquid crystal display according to a second embodiment of the present technology.

FIG. 6 is a configuration diagram illustrating a pixel array section shown in FIG. 5.

FIG. 7 is a layout diagram illustrating the pixel array section shown in FIG. 5.

FIG. 8 is a layout diagram illustrating the pixel array section shown in FIG. 5 according to a modification example.

FIG. 9 is a layout diagram illustrating a sub-pixel according to a comparative example.

FIG. 10 is a cross-sectional view illustrating the sub-pixel according to the comparative example.

FIG. 11 is a perspective view illustrating an electronic device according to an application example.

### DETAILED DESCRIPTION

Hereinafter, embodiments of the present technology will be described in detail with reference to the drawings. The descriptions will be made in the following order:

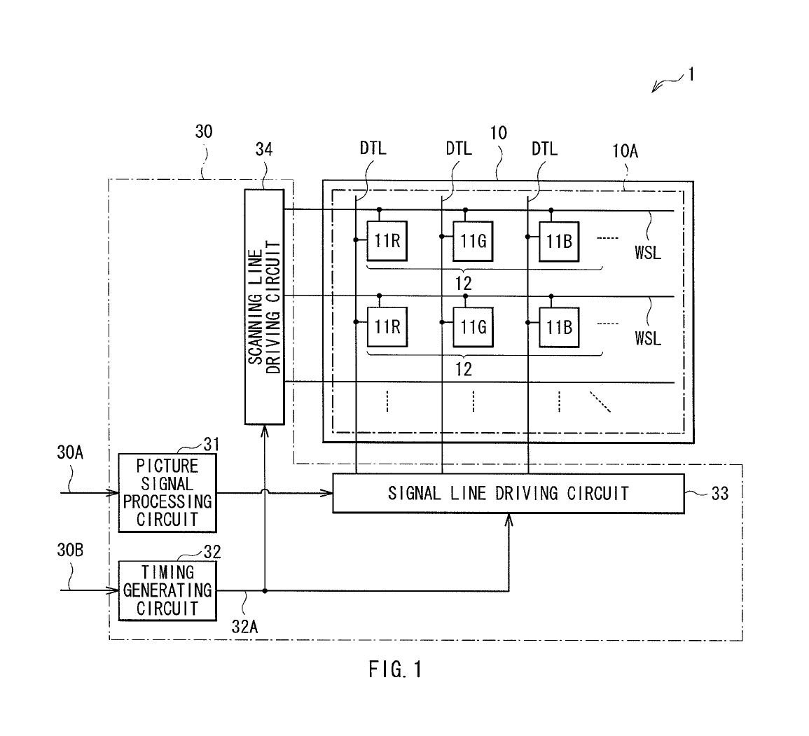

### 1. First Embodiment (FIGS. 1 to 4)

An example in which a gate line is a single gate

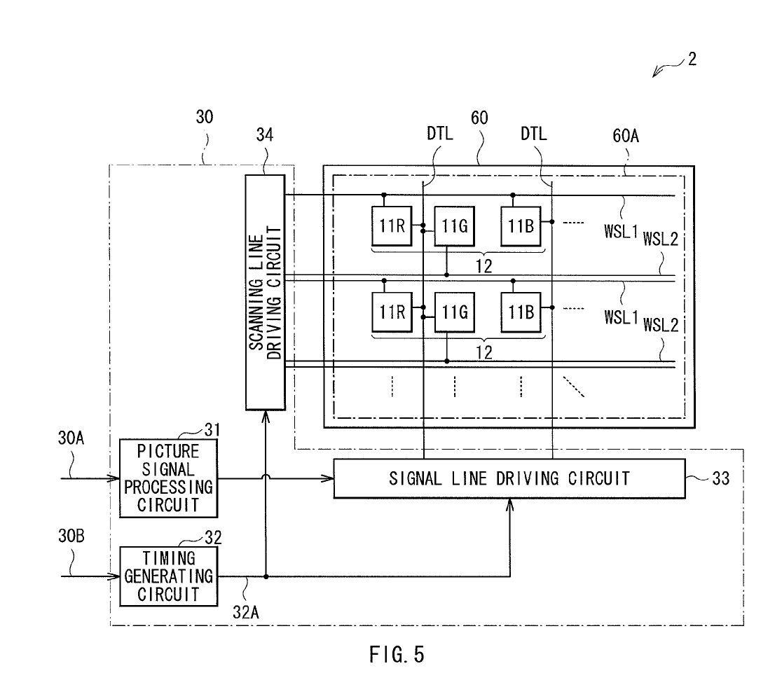

### 2. Second Embodiment (FIGS. 5 to 8)

An example in which a gate line is a dual gate

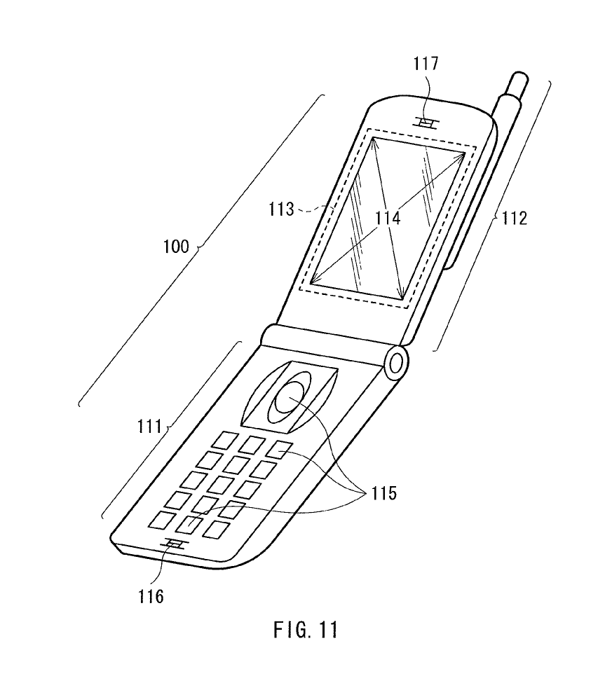

### 3. Application Example (FIG. 11)

An example in which the liquid crystal displays according to the above embodiments are applied to electronic devices

### 1. First Embodiment

### Configuration

FIG. 1 illustrates a schematic configuration of a liquid crystal display 1 according to a first embodiment of the present technology. The liquid crystal display 1 includes a liquid crystal display panel 10 and a driving circuit 30 which drives the liquid crystal display panel 10. In the liquid crystal display 1, a surface of the liquid crystal display panel 10 excluding an outer edge thereof is a display region 10A which displays such as a variety of images and pieces of data, and the surface of the liquid crystal display panel 10 corresponding to a circumferential edge of the display region 10A is a non-display region.

### (Liquid Crystal Display Panel 10)

The liquid crystal display panel 10 is a reflective liquid crystal panel or a semi-transmissive liquid crystal panel combining a reflecting section with a transmitting section. The liquid crystal display panel 10 includes a plurality of pixels 12 which are two-dimensionally arranged in the display region 10A, and displays an image in such a manner that each pixel 12 is driven according to a picture signal 30A. Each pixel 12 includes a plurality of sub-pixels 11R, 11G, and 11B, for example.

The sub-pixel 11R emits red light by selectively transmitting light of a red wavelength band of light reflected by a reflecting electrode described later. The sub-pixel 11G emits green light by selectively transmitting light of a green wavelength band of light reflected by a reflecting electrode described later. The sub-pixel 11B emits blue light by selectively transmitting light of a blue wavelength band of light reflected by a reflecting electrode described later. In the following, the sub-pixels 11R, 11G, and 11B are collectively referred to as sub-pixels 11 where appropriate.

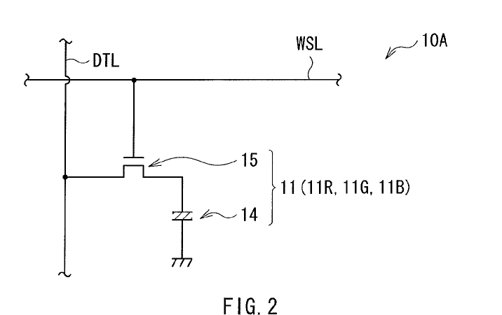

FIG. 2 illustrates an example of the circuit configuration of the display region 10A. The display region 10A includes a plurality of gate lines WSL arranged in rows and a plurality of data lines DTL arranged in columns, as shown in FIGS. 1 and 2, for example. A plurality of sub-pixels 11 are arranged in matrix corresponding to the intersections of the gate lines WSL and the data lines DTL.

Each sub-pixel 11 includes a liquid crystal element 14 and a transistor 15 as shown in FIG. 2, for example. The liquid crystal element 14 has a configuration in which a pixel electrode (pixel electrode 16 described later), an orientation film, a liquid crystal layer (liquid crystal layer 47 described later), an orientation film, and a common electrode (common electrode 48 described later) are stacked on a driving substrate. The driving substrate has a configuration in which the transistor 15 and so forth described above are formed on a glass substrate, for example. The liquid crystal layer includes nematic liquid crystal, and has a modulation function of transmitting or blocking light incoming to the liquid crystal layer on a sub-pixel-to-sub-pixel basis by a voltage applied from the driving circuit 30, for example. The pixel electrode functions as an electrode for each sub-pixel 11 and is arranged in, for example, a region facing the common electrode. With this configuration, when a voltage is applied across the pixel electrode and the common electrode, a longitudinal electric field occurs in the liquid crystal layer. The common electrode is a counter electrode facing the pixel electrode with the liquid crystal layer in between. The common electrode is common to the sub-pixels 11 and is formed throughout the entire display region 10A. The liquid crystal element 14 may have a configuration different from the above configuration. The transistor 15 is, for example, a field-effect Thin-Film Transistor (TFT), and includes a gate which controls a channel, a source provided at one end of the channel, and a drain provided at the other end of the channel.

The liquid crystal element 14 has one end connected to the source or the drain of the transistor 15, and has the other end connected to a reference potential line not shown in the drawings (for example, ground line). The gate of the transistor 15 is connected to the gate line WSL, and one of the source and the drain of the transistor 15, which is not connected to the liquid crystal element 14, is connected to the data line DTL. The gates of the respective transistors 15 of a plurality of sub-pixels 11 of one horizontal line are connected to the common gate line WSL.

### (Driving Circuit 30)

Next, a description will be made, with reference to FIG. 1, of each circuit of the driving circuit 30 provided in the vicinity of the liquid crystal display panel 10. The driving circuit 30 includes a picture signal processing circuit 31, a timing generating circuit 32, a signal line driving circuit 33, and a scanning line driving circuit 34, as shown in FIG. 1, for example.

The picture signal processing circuit 31 corrects a digital picture signal 30A input from the outside, and converts the corrected picture signal into an analog signal to output the analog signal to the signal line driving circuit 33. The timing generating circuit 32 controls the signal line driving circuit 33 and the scanning line driving circuit 34 so that they operate in conjunction with each other. The timing generating circuit 32 outputs a control signal 32A to the circuits according to (in synchronization with) a synchronization signal 30B input from the outside.

The signal line driving circuit 33 applies the analog picture signal input from the picture signal processing circuit 31 (signal potential corresponding to the picture signal 30A) to each data line DTL according to (in synchronization with) the input control signal 32A, to write the analog picture signal into the selected sub-pixel 11. The signal line driving circuit 33 is capable of outputting a signal voltage Vsig corresponding to the picture signal 30A, for example.

The scanning line driving circuit 34 sequentially applies a selecting pulse to a plurality of gate lines WSL according to (in synchronization with) the input of the control signal 32A, and sequentially selects the plurality of sub-pixels 11 for each gate line WSL. The scanning line driving circuit 34 is capable of outputting a voltage Vₒₙ applied when turning on the transistor 15 and a voltage V_{off} applied when turning off the transistor 15. The voltage Vₒₙ is not smaller than an on-voltage of the transistor 15 (fixed value), and the voltage V_{off} is smaller than the on-voltage of the transistor 15 (fixed value).

### (Layout and Cross Section)

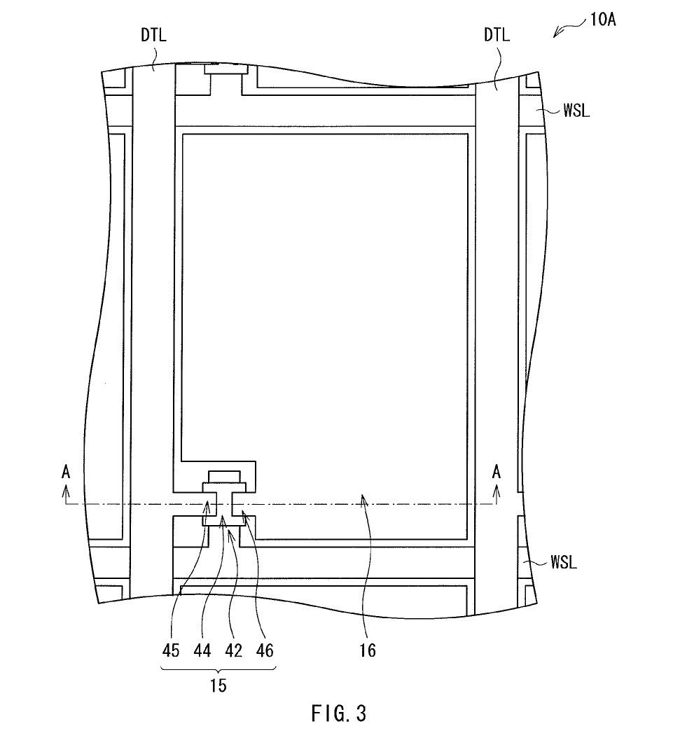

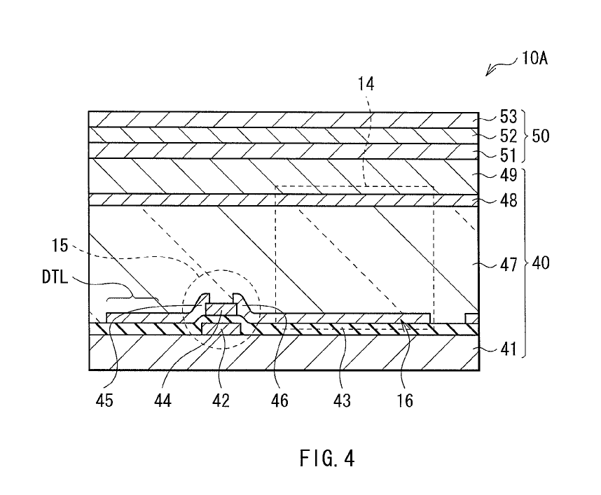

FIG. 3 illustrates an example layout of a part corresponding to the sub-pixel 11 in the display region 10A. FIG. 4 illustrates an example of the cross-sectional configuration of the transistor 15 and the region adjacent to the transistor 15, which is taken along the line A-A of FIG. 3. The sub-pixel 11 has an optical function section 50 on a display panel 40, as shown in FIG. 4, for example.

The display panel 40 has the transistor 15 on a substrate 41, as shown in FIG. 4, for example. The transistor 15 includes, for example, a gate electrode 42, a gate insulating film 43, a channel layer 44, a source electrode 45, and a drain electrode 46 on the substrate 41. The substrate 41 is made of a substrate transparent to visible light, such as a glass plate and a translucent resin substrate. The substrate 41 may be a substrate not transparent to visible light, such as a silicon wafer. The source electrode 45 is formed in the same plane as that of the data line DTL, and is integrated with the data line DTL. Here, the source electrode 45 may be formed separately from the data line DTL in the manufacturing process. The drain electrode 46 is also formed in the same plane as that of the data line DTL, and is arranged away from the data line DTL and the source electrode 45 with a predetermined spacing in between so as not to be in contact with the data line DTL and the source electrode 45. The drain electrode 46 is connected to the pixel electrode 16 of the sub-pixel 11 formed in the same plane as that of the drain electrode 46. The pixel electrode 16 extends over the entire sub-pixel 11 as shown in FIG. 3, for example. The drain electrode 46 is integrated with, for example, the pixel electrode 16. When the drain electrode 46 is integrated with the pixel electrode 16, the drain electrode 46 itself is the pixel electrode 16. It is to be noted that the drain electrode 46 may be formed separately from the pixel electrode 16 in a manufacturing process. The pixel electrode 16 also serves as a reflecting electrode and has a planarized surface (for example, a mirror surface). The drain electrode 46 and the pixel electrode 16 are each formed of metal material such as Al and an Al—Nd alloy, for example.

The display panel 40 has the liquid crystal layer 47 on or above the surface that includes the pixel electrode 16, and has a common electrode 48 and a substrate 49 in this order above the liquid crystal layer 47, as shown in FIG. 4, for example. The liquid crystal layer 47 includes, for example, nematic liquid crystal, and has a modulation function of transmitting or blocking light incoming to the liquid crystal layer 47 on a sub-pixel-to-sub-pixel basis by a voltage applied from the driving circuit 30. The pixel electrode 48 is a counter electrode facing the pixel electrode 16 with the liquid crystal layer 47 in between. The common electrode 48 is common to the sub-pixels 11 and is arranged to face all of the sub-pixels 11. The common electrode 48 is formed of conductive material transparent to visible light, such as ITO (Indium Tin Oxide), for example.

Although not shown in the drawing, a multilayer structure, in which a passivation layer for protecting the transistor 15 and an orientation film for orienting liquid crystal molecules in the liquid crystal layer 47 are stacked in this order from the drain electrode 46, is arranged between the drain electrode 46 and the liquid crystal layer 47. The orientation film is in direct contact with the liquid crystal layer 47. Further, although not shown in the drawing, an orientation film for orienting liquid crystal molecules in the liquid crystal layer 47 is arranged between the liquid crystal layer 47 and the common electrode 48. This orientation film is also in direct contact with the liquid crystal layer 47. Moreover, although not shown in the drawing, a color filter is arranged between the common electrode 48 and the substrate 49.

The color filter has a configuration in which color filters, which separate light having passed through the liquid crystal layer 47 into lights of three different primary colors, that is, red (R) light, green (G) light, and blue (B) light, are arranged corresponding to the arrangement of the pixel electrodes. The color filter has, for example, a filter for red color, a filter for green color, and a filter for blue color, for the sub-pixel 11R, sub-pixel 11G, and sub-pixel 11B, respectively.

The optical function section 50 has a light scattering layer 51, a phase difference layer 52, and a polarizing layer 53 in this order from the display panel 40 as shown in FIG. 4, for example.

The light scattering layer 51 is attached to the upper surface of the substrate 49, for example. The light scattering layer 51 is an optical film in which two types of regions with different refractivities are formed to extend in a thickness direction, and in which each of the refractivities are optically oblique in a predetermined direction, for example. Moreover, the light scattering layer 51 is an anisotropic forward scattering film which scatters light incoming from a specific direction, for example. When the light scattering layer 51 receives light from a specific direction, the light scattering layer 51 transmits the light practically without scattering the light, and greatly scatters light which has come back thereto by being reflected by the reflecting electrode. When the light scattering layer 51 receives light from directions other than the specific direction, the light scattering layer 51 transmits the light practically without scattering the light not only when the light enters from the polarizing layer 53 but also when the light goes to the polarizing layer 53.

The light scattering layer 51 does not have to be in a state of film, and may be an adhesive or a bonding agent which attaches or bonds the substrate 49 and the phase difference layer 52 to each other. Further, the light scattering layer 51 may be arranged in a region other than the region between the substrate 49 and the phase difference layer 52. Specifically, the light scattering layer 51 may be provided between the phase difference layer 52 and the polarizing layer 53, instead of between the substrate 49 and the phase difference layer 52, for example. Moreover, the light scattering layer 51 may be arranged in a region other than the region between the substrate 49 and the phase difference layer 52, in addition to the region between the substrate 49 and the phase difference layer 52. Specifically, the light scattering layer 51 may be provided between the substrate 49 and the phase difference layer 52 and between the phase difference layer 52 and the polarizing layer 53, for example.

The phase difference layer 52 is an optical film of which retardation is equivalent to approximately one fourth of the wavelength of a green light having the highest luminosity factor in the visible light region. The phase difference layer 52 has a function of converting straight polarized light incoming from the polarizing layer 53 into circular polarized light and serves as a quarter-wave plate. Further, a phase difference layer (for example, half-wave plate) of which retardation is equivalent to approximately one half of the wavelength of a green light having the highest luminosity factor in the visible light may be additionally provided between the polarizing layer 53 and the phase difference layer 52 in order to obtain a high bandwidth.

The polarizing layer 53 has a function of absorbing a predetermined straight polarized light component and transmitting polarized light components other than the predetermined straight polarized light component. Hence, the polarizing layer 53 has a function of converting outside light incoming from the outside into straight polarized light.

### <Advantages>

Next, the advantages of the liquid crystal display 1 of the present embodiment will be described.

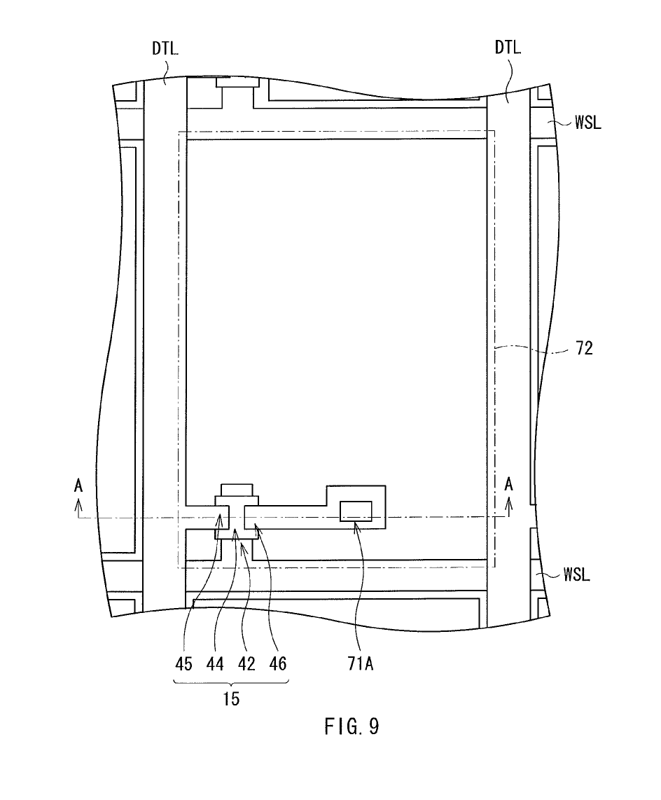

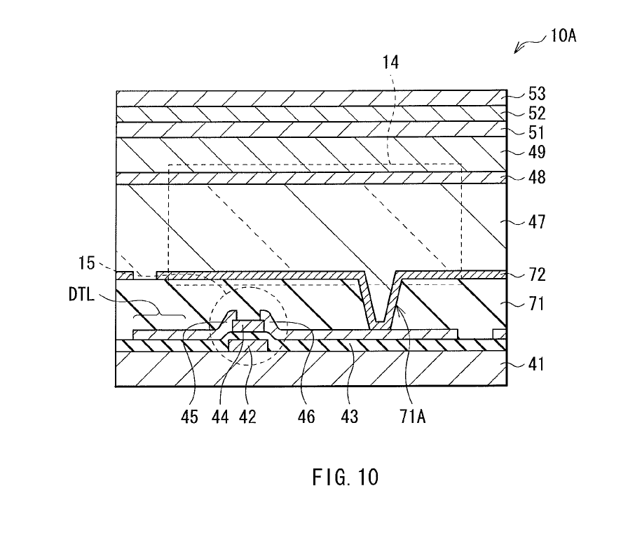

In a typical reflective display device, in order to increase the reflectivity derived from a pixel electrode 72, an interlayer insulating film 71 is provided throughout the entire surface that includes the transistor 15, and a pixel electrode 72 is provided on the interlayer insulating film 71 as shown in FIGS. 9 and 10, where FIG. 10 is a cross-sectional view of FIG. 9 taken along the line A-A of FIG. 9. However, creating such a configuration is disadvantageous in that a large number of process steps are necessary and this prevents reduction in manufacturing cost.

In contrast, in the present embodiment, the pixel electrode 16 is formed in the same layer as that of the drain electrode 46, the source electrode 45, and the data line DTL, and is connected to the drain electrode 46, as shown in FIGS. 3 and 4. Further, in an example where the pixel electrode 16 is integrated with the drain electrode 46, the drain electrode 46 itself functions as the pixel electrode 16. Moreover, in the present embodiment, the pixel electrode 16 serves also as a reflecting electrode. This thus makes it possible to eliminate the interlayer insulating film 71 and the pixel electrode 72 shown in FIGS. 9 and 10. Hence, it is possible to reduce the number of the process steps, thereby lowering the manufacturing cost, without damaging the function as a reflective display device.

### 2. Second Embodiment

FIG. 5 illustrates a schematic configuration of a liquid crystal display 2 according to a second embodiment of the present technology. The liquid crystal display 2 includes a liquid crystal display panel 60, and a driving circuit 30 which drives the liquid crystal display panel 60. In the liquid crystal display 2, a surface of the liquid crystal display panel 60 excluding an outer edge thereof is a display region 60A which displays such as a variety of images and pieces of data, and the surface of the liquid crystal display panel 60 corresponding to a circumferential edge of the display region 60A is a non-display region.

### (Liquid Crystal Display Panel 60)

The liquid crystal display panel 60 is a reflective liquid crystal panel or a semi-transmissive liquid crystal panel combining a reflecting section with a transmitting section. The liquid crystal display panel 60 includes a plurality of pixels 12 which are two-dimensionally arranged in the display region 60A, and displays an image in such a manner that each pixel 12 is driven according to the picture signal 30A.

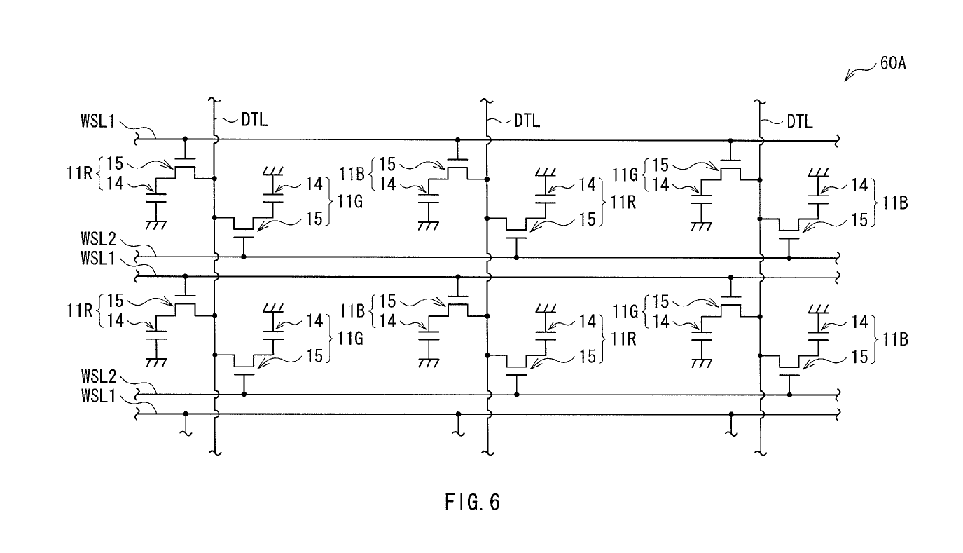

FIG. 6 illustrates an example of the circuit configuration in the display region 60A. The display region 60A has a plurality of sets of gate lines WSL1 and WSL2 arranged in rows and a plurality of data lines DTL arranged in columns as shown in FIGS. 5 and 6, for example. The plurality of sets of gate lines WSL1 and WSL2 are connected to the scanning line driving circuit 34 and are sequentially (at different times) driven by the scanning line driving circuit 34.

In the plurality of sub-pixels 11 belonging to one horizontal line, two sub-pixels 11 are connected to one data line DTL, and those sub-pixels 11 are connected to respective different gate lines WSL1 and WSL2. Thus, the liquid crystal display panel 60 is a display panel of a dual-gate type.

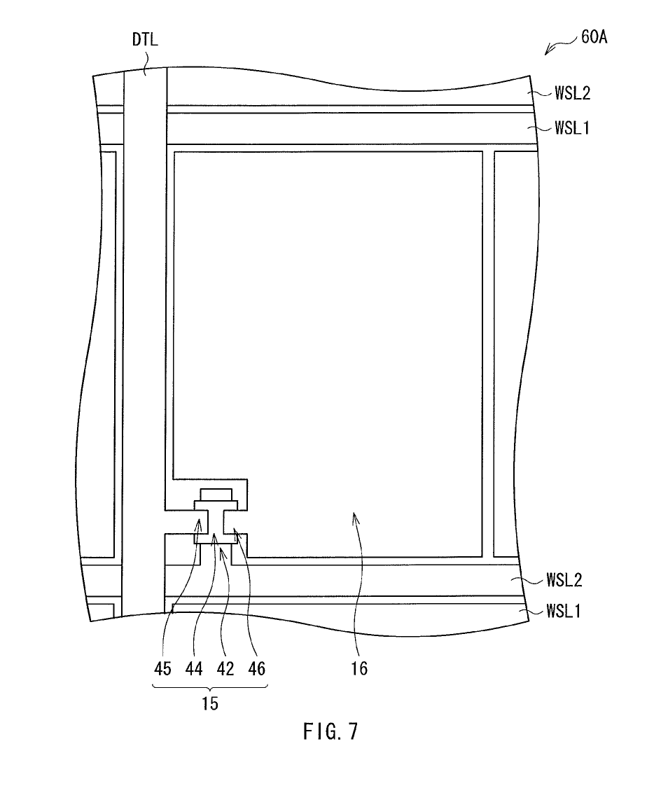

FIG. 7 illustrates an example layout of the part corresponding to the sub-pixel 11 in the display region 60A. As shown in FIG. 7, there is no data line DTL between two sub-pixels 11 which are connected to respective different data lines DTL in the plurality of sub-pixels 11 belonging to one horizontal line. The absence of data line DTL increases the area of the pixel electrode 16 (or drain electrode 46). On the other hand, the area of the pixel electrode 16 (or drain electrode 46) is reduced by the presence of the gate line WSL2, since the liquid crystal display panel 60 is a dual-gate type. However, the sub-pixel 11 is rectangular in shape, that is, the sub-pixel 11 is short in a horizontal direction and long in a vertical direction. Thus, the area increased by the absence of the data line DTL extending in a longer direction of the sub-pixel 11 is larger than the area reduced by the presence of the gate line WSL2 extending in a shorter direction thereof. Hence, in the liquid crystal display panel 60 of a dual-gate type, it is possible to make the area of the pixel electrode 16 (or drain electrode 46) larger than that of the pixel electrode 16 (or drain electrode 46) in the first embodiment, making it possible to make the aperture ratio of each sub-pixel 11 larger than that in the first embodiment as well.

### [Modification]

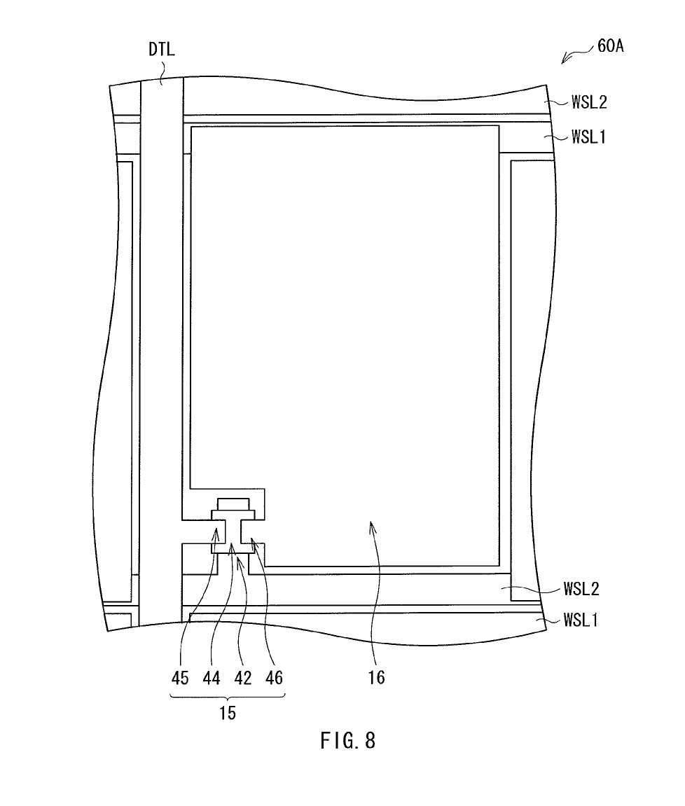

In the second embodiment, the pixel electrode 16 (or drain electrode 46) may extend to a region immediately above the gate line WSL1 to which the gate of the transistor 15 of another sub-pixel 11 is connected, as shown in FIG. 8, for example. In this case, it is possible to further increase the aperture ratio of each sub-pixel 11.

### 3. Application Example

Next, an application example of the liquid crystal displays 1 and 2 according to the embodiments and the modification will be described. FIG. 11 is a perspective view illustrating an example of the schematic configuration of an electronic device 100 according to the present application example. The electronic device 100, for example, is a mobile phone having a body section 111 and a display body section 112 provided openable and closable on the body section 111, as shown in FIG. 11. The body section 111 has an operation bottom 115 and a mouthpiece section 116. The display body section 112 has a display device 113 and an earpiece section 117. The display device 113 performs a variety of displays regarding telephone communication on a display screen 114 of the display device 113. The electronic device 100 has a control section (not shown in the drawings) for controlling the operation of the display device 113. The control section is provided as a part of a controller for controlling the overall electronic device 100. Alternatively, the control section may be provided in the body section 111 or in the display body section 112, separately from the controller.

The display device 113 has the same configuration as that of the liquid crystal display 1 according to the embodiments and the modification. Hence, it is possible to reduce the manufacturing cost of the display device 113 by the reduction in the number of process steps.

Examples of electronic devices to which the liquid crystal displays 1 and 2 according to the embodiments and the modification are applicable include not only the mobile phone described above but also, for example but not limited to, personal computers, liquid crystal televisions, video tape recorders of a viewfinder type or monitor direct-view type, car navigation systems, pagers, electronic organizers, electronic calculators, word processors, work stations, television telephones, and POS terminals.

Thus, it is possible to achieve at least the following configurations from the above-described example embodiments, the modifications, and the application examples of the disclosure.

(1) A display panel, including:

a liquid crystal element; and

a transistor including a gate electrode, a source electrode, and a drain electrode,

wherein the liquid crystal element and the transistor are provided for each sub-pixel, and

the drain electrode serves as a pixel electrode that drives the liquid crystal element.

(2) The display panel according to (1), further including:

a plurality of gate lines arranged in rows; and

a plurality of data lines arranged in columns,

wherein the sub-pixels are arranged in matrix, corresponding to a layout of the gate lines and the data lines, and

the drain electrode is arranged in a same layer as a layer provided with the data lines.

(3) The display panel according to (1) or (2), wherein the drain electrode serves as a reflecting electrode.
(4) A display panel, including:

a liquid crystal element including, as a multilayer, a pixel electrode, a counter electrode, and a liquid crystal layer disposed in between; and

a transistor including a gate electrode, a source electrode, and a drain electrode,

wherein the liquid crystal element and the transistor are provided for each sub-pixel, and

the pixel electrode is connected to the drain electrode and is arranged in a same layer as a layer provided with the drain electrode.

(5) A display panel, including:

a plurality of gate lines arranged in rows;

a plurality of data lines arranged in columns; and

a plurality of sub-pixels arranged in matrix, corresponding to a layout of the gate lines and the data lines, each of the sub-pixels including a liquid crystal element and a transistor,

wherein the liquid crystal element includes, as a multilayer, a pixel electrode, a counter electrode, and a liquid crystal layer disposed in between, and

the pixel electrode is arranged in a same layer as a layer provided with the data lines.

(6) The display panel according to (4) or (5), wherein the pixel electrode serves as a reflecting electrode.
(7) A display device with a display panel and a driving section, the display panel including a plurality of sub-pixels arranged in matrix, and the driving section driving the display panel, the display panel including:

a liquid crystal element; and

a transistor including a gate electrode, a source electrode, and a drain electrode,

wherein the liquid crystal element and the transistor are provided for each of the sub-pixels, and

the drain electrode serves as a pixel electrode that drives the liquid crystal element.

(8) The display device according to (7), further including:

a plurality of gate lines arranged in rows; and

a plurality of data lines arranged in columns,

wherein the sub-pixels are arranged in matrix, corresponding to a layout of the gate lines and the data lines, and

the drain electrode is arranged in a same layer as a layer provided with the data lines.

(9) The display device according to (7) or (8), wherein the drain electrode serves as a reflecting electrode.
(10) A display device with a display panel and a driving section, the display panel including a plurality of sub-pixels arranged in matrix, and the driving section driving the display panel, the display panel including:

a liquid crystal element including, as a multilayer, a pixel electrode, a counter electrode, and a liquid crystal layer disposed in between; and

a transistor including a gate electrode, a source electrode, and a drain electrode,

wherein the liquid crystal element and the transistor are provided for each of the sub-pixels, and

the pixel electrode is connected to the drain electrode and is arranged in a same layer as a layer provided with the drain electrode.

(11) A display device with a display panel and a driving section, the display panel including a plurality of sub-pixels arranged in matrix, and the driving section driving the display panel, the display panel including:

a plurality of gate lines arranged in rows;

a plurality of data lines arranged in columns; and

a plurality of sub-pixels arranged in matrix, corresponding to a layout of the gate lines and the data lines, each of the sub-pixels including a liquid crystal element and a transistor,

wherein the liquid crystal element includes, as a multilayer, a pixel electrode, a counter electrode, and a liquid crystal layer disposed in between, and

the pixel electrode is arranged in a same layer as a layer provided with the data lines.

(12) The display device according to (10) or (11), wherein the pixel electrode serves as a reflecting electrode.

The present disclosure contains subject matter related to that disclosed in Japanese Priority Patent Application JP 2011-094268 filed in the Japan Patent Office on Apr. 20, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display panel, comprising:
a liquid crystal element; and
a transistor including a gate electrode, a source electrode, and a drain electrode,
wherein the liquid crystal element and the transistor are provided for each sub-pixel, and
the drain electrode serves as a pixel electrode that drives the liquid crystal element.

2. The display panel according to claim 1, further comprising:
a plurality of gate lines arranged in rows; and
a plurality of data lines arranged in columns,
wherein the sub-pixels are arranged in matrix, corresponding to a layout of the gate lines and the data lines, and
the drain electrode is arranged in a same layer as a layer provided with the data lines.

3. The display panel according to claim 1, wherein the drain electrode serves as a reflecting electrode.

4. A display panel, comprising:
a liquid crystal element including, as a multilayer, a pixel electrode, a counter electrode, and a liquid crystal layer disposed in between; and
a transistor including a gate electrode, a source electrode, and a drain electrode,
wherein the liquid crystal element and the transistor are provided for each sub-pixel, and
the pixel electrode is connected to the drain electrode and is arranged in a same layer as a layer provided with the drain electrode.

5. The display panel according to claim 4, wherein the pixel electrode serves as a reflecting electrode.

6. A display panel, comprising:
a plurality of gate lines arranged in rows;
a plurality of data lines arranged in columns; and
a plurality of sub-pixels arranged in matrix, corresponding to a layout of the gate lines and the data lines, each of the sub-pixels including a liquid crystal element and a transistor,
wherein the liquid crystal element includes, as a multilayer, a pixel electrode, a counter electrode, and a liquid crystal layer disposed in between, and
the pixel electrode is arranged in a same layer as a layer provided with the data lines.

7. The display panel according to claim 6, wherein the pixel electrode serves as a reflecting electrode.

8. A display device with a display panel and a driving section, the display panel including a plurality of sub-pixels arranged in matrix, and the driving section driving the display panel, the display panel comprising:
a liquid crystal element; and
a transistor including a gate electrode, a source electrode, and a drain electrode,
wherein the liquid crystal element and the transistor are provided for each of the sub-pixels, and
the drain electrode serves as a pixel electrode that drives the liquid crystal element.

9. A display device with a display panel and a driving section, the display panel including a plurality of sub-pixels arranged in matrix, and the driving section driving the display panel, the display panel comprising:
a liquid crystal element including, as a multilayer, a pixel electrode, a counter electrode, and a liquid crystal layer disposed in between; and
a transistor including a gate electrode, a source electrode, and a drain electrode,
wherein the liquid crystal element and the transistor are provided for each of the sub-pixels, and
the pixel electrode is connected to the drain electrode and is arranged in a same layer as a layer provided with the drain electrode.

10. A display device with a display panel and a driving section, the display panel including a plurality of sub-pixels arranged in matrix, and the driving section driving the display panel, the display panel comprising:
a plurality of gate lines arranged in rows;
a plurality of data lines arranged in columns; and
a plurality of sub-pixels arranged in matrix, corresponding to a layout of the gate lines and the data lines, each of the sub-pixels including a liquid crystal element and a transistor,
wherein the liquid crystal element includes, as a multilayer, a pixel electrode, a counter electrode, and a liquid crystal layer disposed in between, and
the pixel electrode is arranged in a same layer as a layer provided with the data lines.
